(19) United States
(12) Patent Application Publication
(10) Pub. No.: US 2009/0225060 A1
(43) Pub. Date: Sep. 10, 2009

(54) WRIST-MOUNTED LASER WITH ANIMATED, PAGE-BASED GRAPHICAL USER-INTERFACE

(76) Inventors: Ioana M. Rizoiu, San Clemente, CA (US); Dmitri Boutoussov, Dana Point, CA (US)

Correspondence Address: Kenton R. Mullins;Stout, Uxa, Buyan & Mullins, LLP, Suite 300, 4 Venture, Irvine, CA, 92618, US

(21) Appl. No.: 12/372,690

(22) Filed: Feb. 17, 2009

Related U.S. Application Data
(63) Continuation-in-part of application No. 11/820,746, filed on Jun. 19, 2007.
Application No. 11/820,746 is a continuation-in-part of application No. 11/800,435, filed on May 3, 2007.
Application No. 11/800,435 is a continuation-in-part of application No. 11/800,434, filed on May 3, 2007.
(60) Provisional application No. 61/030,997, filed on Feb. 24, 2008.
(60) Provisional application No. 61/030,976, filed on Feb. 24, 2008.
(60) Provisional application No. 61/029,305, filed on Feb. 15, 2008.

(51) Int. Cl. G06F 3/042; G06F 3/041; G06F 3/048

(52) U.S. Cl. 345/176; 715/702; 715/772; 715/835; 715/776; 715/766

(57) ABSTRACT

A graphical user interface is described that controls an electromagnetic energy output system. A touchscreen presents control icons and receives input from a user; the input being used to control the electromagnetic energy output system. The interface permits modifying stored values of preset operating parameters.

### CROSS-REFERENCE TO RELATED APPLICATIONS

This application claims the benefit of U.S. Provisional Application No. 61,030,997, filed Feb. 24, 2008 and entitled WRIST-MOUNTED LASER WITH ANNIMATED, PAGE-BASED GRAPHICAL USER-INTERFACE (Att. Docket No. BI9975CIP4PR2), U.S. Provisional Application No. 61,030,976, filed Feb. 24, 2008 and entitled FLUID CONTROLLABLE LASER ENDODONTIC CLEANING AND DISINFECTING SYSTEM (Att. Docket B18083PR), and U.S. Provisional Application No. 61,029,305, filed Feb. 15, 2008 and entitled WRIST-MOUNTED LASER WITH SCROLLABLE GRAPHICAL USER-INTERFACE (Att. Docket BI9975CIP4PR). U.S. Provisional Application No. 61,030,997 incorporates by reference the contents of U.S. Provisional Application No. 60/932,409, filed May 30, 2007 and entitled METHOD AND APPARATUS FOR CONTROLLING AN ELECTROMAGNETIC ENERGY OUTPUT SYSTEM (Att. Docket B19975CIP3PR) and U.S. Provisional Application No. 60/921,057, filed Mar. 29, 2007 and entitled WRIST-MOUNT ELECTROMAGNETIC ENERGY EMITTING DEVICE (Att. Docket BI9975CIP2PR). This application is a continuation-in-part of U.S. application Ser. No. 11/820,746, filed Jun. 19, 2007 and entitled METHOD AND APPARATUS FOR CONTROLLING AN ELECTROMAGNETIC ENERGY OUTPUT SYSTEM (Att. Docket B19975CIP3), U.S. application Ser. No. 11/800,435, filed May 3, 2007 and entitled WRIST-MOUNT ELECTROMAGNETIC ENERGY EMITTING DEVICE (Att. Docket B19975CIP2), and U.S. Application No. 11/800,434, filed May 3, 2007 and entitled ELECTROMAGNETIC ENERGY OUTPUT SYSTEM (Att. Docket BI9975CIP). The entire contents of all of the above applications, and of all of the disclosures referenced therein, and of all of the disclosures referenced in those referenced disclosures, are hereby incorporated by reference in their entireties.

### BACKGROUND OF THE INVENTION

1. Field of the Invention

The present invention relates generally to devices for generating output optical energy distributions and, more particularly, to user interfaces for such devices.

2. Description of Related Art

A variety of electromagnetic energy generating device architectures have existed in the prior art. A solid-state laser system, for example, generally comprises a laser rod for emitting coherent light and a source for stimulating the laser rod to emit the coherent light. The coherent light, which may be referred to as a laser beam, may be delivered to a target surface through a fiber optic waveguide. Care must be exercised to ensure that the laser beam possesses properties appropriate for performance of an intended function. Properties of a laser beam employed in the cutting or removal of, for instance, dental hard tissue may differ from properties of a laser beam employed to coagulate blood in soft tissue. A laser beam may be described by its fluence or power density, which may in turn be measured in, for example, watts per square meter (W/m²), milliwatts per square centimeter (mW/cm²), or the like. Common practice has determined preferred values for fluence or power density levels, depending upon procedures to be performed.

It is important that a user be able to easily, precisely, and accurately control aspects of electromagnetic energy generation including, for example, power level, energy level, pulse duration, and the like.

### SUMMARY OF THE INVENTION

The present invention addresses the need for convenient, precise, and accurate control of electromagnetic energy by providing a method and apparatus for controlling an electromagnetic energy output system. The invention herein disclosed, according to one aspect, provides a laser handpiece adapted to generate electromagnetic energy according to preset parameter values, the preset parameter values being adjustable by using a graphical user interface. A representative embodiment of the graphical user interface comprises a touchscreen disposed on a portable assembly easily held in a hand of a user. The portable assembly may be operably connected with an electromagnetic energy source. A plurality of electromagnetic energy control icons may be displayed on the touchscreen, wherein the electromagnetic energy source is responsive to inputs caused by touching at least one of the electromagnetic energy control icons.

A particular embodiment of the graphical user interface comprises a power level indicator adapted to display a level of power generated by the electromagnetic energy source. For example, the plurality of electromagnetic energy control icons may comprise a power increase icon that controls an increase in the level of power generated by the electromagnetic energy source and a power decrease icon that controls a decrease in the level of generated power.

According to another aspect of the disclosure, the plurality of electromagnetic energy control icons may comprise an energy mode icon, which may control a selection of one of generating electromagnetic energy in a pulsed mode and generating electromagnetic energy in a continuous wave mode.

Yet another aspect of the present invention provides a laser handpiece adapted to independently adjust pulse length and pulse interval of electromagnetic energy generated in the pulse mode, the laser handpiece being operably connected to a computer disposed in a portable assembly easily held in a hand. One embodiment of the computer comprises a processor, working memory, program memory, and a graphical user interface that includes a touchscreen. The embodiment may further include an interface to an electromagnetic energy source adapted to be controlled by the processor and a system bus that communicatively interconnects the processor, working memory, program memory, graphical user interface, and the interface to the electromagnetic energy source. The program memory may have stored therein a power level software module that causes the processor to receive a power level input from the graphical user interface and to communicate with the electromagnetic energy source to control a power level of the electromagnetic energy source according to the power level input.

While the apparatus and method has or will be described for the sake of grammatical fluidity with functional explanations, it is to be expressly understood that the claims, unless expressly formulated under 35 U.S.C. 112, are not to be construed as necessarily limited in any way by the construction of “means” or “steps” limitations, but are to be accorded the full scope of the meaning and equivalents of the definition provided by the claims under the judicial doctrine of equivalents, and in the case where the claims are expressly formulated under 35 U.S.C. 112 are to be accorded full statutory equivalents under 35 U.S.C. 112.

Any feature or combination of features described herein are included within the scope of the present invention provided that the features included in any such combination are not mutually inconsistent as will be apparent from the context, this specification, and the knowledge of one skilled in the art. For purposes of summarizing the present invention, certain aspects, advantages and novel features of the present invention are described herein. Of course, it is to be understood that not necessarily all such aspects, advantages or features will be embodied in any particular embodiment of the present invention. Additional advantages and aspects of the present invention are apparent in the following detailed description and claims that follow.

### BRIEF DESCRIPTION OF THE FIGURES

FIG. 1A depicts a body-mount implementation of an electromagnetic energy output device according to an aspect of the present invention;

FIGS. 1-9 are two-dimensional representations of implementations of touchscreen displays in a graphical user interface suitable for controlling an electromagnetic energy output system;

FIGS. 9A-9G are two-dimensional representations of implementations of touchscreen displays for facilitating modification of preset values of parameters that control an electromagnetic energy output system;

FIGS. 10-12 are two-dimensional representations of implementations of touchscreen displays of a graphical user interface for controlling an electromagnetic energy output system;

FIG. 13 is a block diagram of an embodiment of a computer system adapted to implement the touchscreen displays of FIGS. 1-12; and

FIG. 14 is a flow diagram illustrating one implementation of a method of controlling an electromagnetic energy output system.

### DETAILED DESCRIPTION OF THE INVENTION

Reference will now be made in detail to embodiments of the invention, examples of which are illustrated in the accompanying drawings. Wherever possible, the same or similar reference numbers are used in the drawings and the description to refer to the same or like parts. It should be noted that the drawings are in simplified form and are not to precise scale. In reference to the disclosure herein, for purposes of convenience and clarity only, directional terms, such as, top, bottom, left, right, up, down, over, above, below, beneath, rear, and front, are used with respect to the accompanying drawings. Such directional terms should not be construed to limit the scope of the invention in any manner.

Although the disclosure herein refers to certain illustrated embodiments, it is to be understood that these embodiments are presented by way of example and not by way of limitation. The intent of this disclosure, while discussing exemplary embodiments, is that the following detailed description be construed to cover all modifications, alternatives, and equivalents of the embodiments as may fall within the spirit and scope of the invention as defined by the appended claims. It is to be understood and appreciated that the process steps and structures described herein do not cover a complete process flow for the control of electromagnetic energy output systems. The present invention may be practiced in conjunction with various computer, display, and laser control techniques that are conventionally used in the art, and only so much of the commonly practiced process steps are included herein as are necessary to provide an understanding of the present invention. The present invention has applicability in the field of electromagnetic energy generating devices in general. For illustrative purposes, however, the following description pertains to a method and apparatus for controlling a hand-held medical laser.

According to an aspect of the present invention, a wrist-mount electromagnetic energy emitting (e.g., lasing) device is disclosed. An aspect of the present invention comprises moving forward, along a line of delivery system component locations, components of a lasing device so that they are closer to the target. More particularly, components of the wrist-mount lasing device are configured to be positioned more forwardly, so that they are disposed closer to the target as compared to locations of components of typical prior-art systems. In other words, a substantial number of the elements of the wrist-mount lasing device, and in certain implementations all of the elements of the device, according to certain aspects of the present invention, are operatively disposed in a relatively close proximity to the target. While referenced herein as a lasing device, it is intended that the energy source be interpreted to cover electromagnetic energy sources in general rather than just laser systems.

One feature of the present invention provides for the coupling of a wrist-mount lasing device to a non-horizontal surface. Horizontal surface real-estate can be at a premium during lasing procedures, so that movement (and subsequent repositioning) of the wrist-mount lasing device from proximity of such surfaces can free-up the surfaces for other tools or uses. The wrist-mount lasing device does not, in certain implementations, require a surface or mount for placement on a counter or mounting on wall. Accordingly, horizontal surfaces are conserved. Attachment of the wrist-mount lasing device to a part of the body (e.g., the body, or clothing on the body) can, in addition to and/or as a consequence of alleviating a requirement for the wrist-mount lasing device to be mounted on the surface of a floor, countertop, or wall, attenuate a number or length of required cables, a fatigue of the user, an apprehension of a patient, an amount of clutter in a procedural area, and an amount of set-up time and/or clean-up time of a procedure. As defined herein, the user may be, for example, a physician, technician, or other professional seeking to perform a procedure, or may be a recipient of the procedure such as a patient.

In typical implementations, the wrist-mount lasing device can be mounted to a part of the user's body or clothing/apparel.

It has been discovered that, in conjunction with the coupling (e.g., mounting) of a wrist-mount lasing device, implementation of battery power can enhance the coupling. Moreover, as compared to a conventional disposition of a lasing device on a horizontal support surface, it has been discovered that, in the context of coupling of the wrist-mount lasing device to the mentioned non-horizontal surface or living creature, the of a user interface with fewer hard (physical) buttons and/or more of a display/software user interface (e.g., comprising more soft key and/or touch screen inputs, as compared to prior-art constructions) can facilitate a greater usability or versatility of the wrist-mount lasing device due to, for example, the less-restricting physical nature of the coupling. Similarly, as compared to a conventional lasing device, the coupling of the wrist-mount lasing device to the mentioned non-horizontal surface or living creature can provide greater operability and efficiency when implemented with shorter cables and/or fibers.

According to exemplary body-mount embodiments, the wrist-mount lasing device can be mounted, for example, to a writs or arm of the user. The wrist-mount lasing device may be affixed to the user's upper arm using an arm band, or may be attached to the user's wrist using a wrist strap or bracelet.

A possible net result of the current invention's implementation of a wrist-mount lasing system can be to at least partially, and in certain aspects, dramatically, enhance one or more of a safety (e.g., from a simpler assembly, less clutter on floor/table surfaces and/or less likelihood of user confusion/error), a versatility (e.g., movement/maneuverability of the device to/in or use of the device in more applications), and an efficiency (e.g., shorter fiber optic, less assembly/disassembly). Another possible net result of the implementation of a wrist-mount lasing system according to the present invention can be to at least partially, and in certain aspects, dramatically, attenuate one or more of a manufacturing cost (e.g., from more compact, fewer or shorter components), an operational and/or maintenance cost (e.g., from delivery of energy over a smaller distance, resulting in fewer energy loses during use), and a subjective element experienced by the patient during a medical procedure (e.g., from more discrete and/or less formidable-looking equipment, as compared to typical prior-art systems).

Following coupling of part or all of the components of a wrist-mount lasing device to a part of the body of a user, such as the arm (e.g., wrist), the user may not need to grip and hold, or may not need to grip and hold as much, the component(s), thus potentially freeing-up, or partially freeing-up, one or more of a functionality and a profile of that hand. Furthermore, freeing-up of one or more fingers of the user's hand (e.g., by finger mounting the output configuration) can provide, or provide further, that hand with one or more of a smaller profile and a greater procedural maneuverability or functionality. Thus, when not committed to the holding of a conventional laser handpiece, the user's hand may be used to perform other tasks as the user may not need to grip and hold as many components or may not need to grip and hold them to the same extent. Thus, fingers of the user's hand may be free, or at least potentially less burdened, for the performance of other tasks.

Furthermore, when inputting data into the device immediately before, during, or immediately following a procedure, the user does not have move away or look away from the site of the procedure to adjust parameters, as they can be adjusted on the user's wrist or arm. The display, furthermore, can be an object-oriented display that is intuitive and that can be rapidly navigated by a new or a seasoned user of the system with ease. For example, objects or icons in the display may comprise images of or symbols representing one or more of different procedural modes, tissue types, output tips, and other parameters disclosed or referenced herein. As one implementation, a desktop type of display and operability is implemented. According to certain aspects of the present invention, sliding animations, or one or more of any other structure, feature, step, or method, such as disclosed in, for example, U.S. Patent Application Pub. No. 20040055446 and U.S. Pat. No. 7,225,409, the contents of which are incorporated herein by reference, may be incorporated or modified to be incorporated, in any combination and/or permutation, with any part of the current disclosure. For instance, a plurality of buttons can be integrated into a scroll wheel with a sliding or scrolling animations display feature, to provide any implementation of the current invention with an intuitive, uncluttered, minimalistic interface. A desktop type of user interface display, for example, may be scrollable using a scroll wheel, and, furthermore, particular icons on the desktop, when selected and opened, may contain scrollable displays with selectable items. As an addition or alternative to a scroll wheel, up and down arrows, among other controls, may be implemented. Such a scrollable desktop may be embodied by creation of a single, oversized desktop that extends beyond the visible region of the display, wherein only a portion of the desktop is visible at a time and wherein the portion of the desktop being displayed (i.e., the view) can be moved, along with opened and unopened objects and windows on the desktop being movable as well.

A procedure or a sub-procedure can be described as a set (“chain”) of steps and considerations, one or more (e.g., each) of which may or should be implemented with certain pieces of equipment, equipment settings, equipment arrangements, surgical staff present, methodologies, observations, mental checkpoints, etc., and of which may differ from one or more prior steps or subsequent steps.

Such chains, and steps making up the chains, according to an aspect of the invention, may be displayed in a selectable and navigatable format to guide the user. For example, a general display may comprise a listing, menu, or outline of elements (e.g., general steps) of a chain or chains, with one or more of the elements being selectable by the user to open-up or move-to another (e.g., more detailed) display presenting further information, and/or a further menu, on or relating to the selected element. Selection of the element may comprise moving a displayed pointing device over the element or highlighting the element, followed by entering one or more confirmation inputs (e.g., a click of a pointing device, a depression of a button or arrow on a housing of the user interface, the tapping once on a return or enter key, a contacting of a user's finger or stylus on a part of a touchscreen, etc.), selecting on the display a number or other item or icon corresponding to the element, selecting a “next” or “previous” icon, providing a voice activated command, etc.

According to one aspect of the invention, a paradigm for facilitating navigation through and among chains comprises animated or virtual stacks or tablets (“groups”) of pages. To name a few examples, the groups may comprise, in any combination or permutation, settings, instructions, a user manual of the laser device, databases of records or other items (e.g., a collection of prior procedures for each patient), associations of information such as steps (e.g., pertaining to and guiding a user through a sequence of desensitizing, cutting, coagulating, settings and steps, etc.). The paradigm may be used in whole or in part, in any combination or permutation, with any one or more of the above described and referenced (or otherwise described or referenced, herein,) navigation and information-presentation architectures and methodologies. Combinations of groups can be displayed using any one or more of stacked, partially overlapping, and fully overlapping images. The elements, groups, and/or combinations of groups, can be factory installed and/or creatable or modifiable by a user.

In certain embodiments of the paradigm, each group may comprise, for example, a top virtual page and additional virtual pages beneath it. A user can move through the pages as he or she would through an actual (e.g., non-virtual) stack or tablet of pages. Thus, a top page may comprise a listing, menu, or outline of elements (e.g., general steps) of a chain or chains, with one or more of the elements on the top page being selectable by the user (“the selected element”) to open-up or move to another (e.g., a more detailed) page or element (or other association of elements and/or groups) which may present further information (in any format described or referenced herein), and/or present a further menu (or other association of elements and/or groups) on or relating to the selected element on the page. In one implementation, the listing, menu or outline of elements may resemble a table of contents such as may be contained in a book. Selection of a given element on a page may comprise moving a displayed pointing device over the element or highlighting the element, and/or entering one or more confirmation inputs (e.g., one or more of a click of a pointing device, depression of a button or arrow on a housing of the user interface, a return or enter key, and a contacting of a user's finger or stylus on a part of a touchscreen), etc.

Typically, the selection of a given element or group, displayed for example in the format of a stack or tablet, can comprise virtually selecting an edge or corner (or, in other embodiments, another portion) of the page. In an implementation utilizing a touchscreen display, the edge or corner of the page may be selected (contacted) by the user touching it with his or her finger or stylus and, while still contacting it, moving or sliding the finger or stylus to the left so as to “flip” or “turn” the page as would occur with a non-virtual page of a book. As with a non-virtual tablet or stack of pages, a user can be provided with the option of navigating back through virtual pages (e.g., in a direction toward a previously viewed, flipped, or turned page) by flipping or turning pages in a manner whereby touching or selecting of an edge or corner (e.g., an edge or corner on the page opposite to the edge or corner last-used to flip or turn the page in the opposite direction) of each virtual page and moving or sliding the finger or stylus to the right will flip or turn the page.

Also, in typical implementations, one or more of the elements on, for example, the first page of, for example, a group may comprise groups of pages (and/or elements), as well. According to one implementation, groups of pages (and/or elements), corresponding to chains (and/or other pieces of information), as described herein, are displayed (e.g., animated) on the virtual desktop of the display.

With reference to the body-attachment (e.g., wrist mount) implementation of the invention, such a wrist-mount lasing device can comprise, for example, a housing with a body attachment (e.g., a wrist band), an output configuration for outputting electromagnetic radiation, and a wave guide (e.g., fiber optic) for delivering electromagnetic radiation from the housing to the output configuration. In certain embodiments of the present invention, the output configuration may take the form of, for example, one or more of a thumbpiece, a fingerpiece, a fiber optic tip, and a distal end (e.g., a distal part) of a fiber optic. Fiber optic tips, according to one feature of the present invention, can be formed (e.g., of solid glass) with radiation output orifices of 3-10 mm corresponding, for example, to photo-biomodulation or low-level light therapy (LLLT) embodiments. Regarding low-level light therapy techniques, any combination or permutation of components, systems and steps of or in connection with any wrist-mount lasing device described or referenced herein can be used or implemented, to any extent and in any combination or permutation, with any one or more of the components, systems and steps disclosed or referenced in U.S. application Ser. No. 11/447,605, filed Jun. 5, 2006, the entire contents of which are expressly incorporated herein by reference.

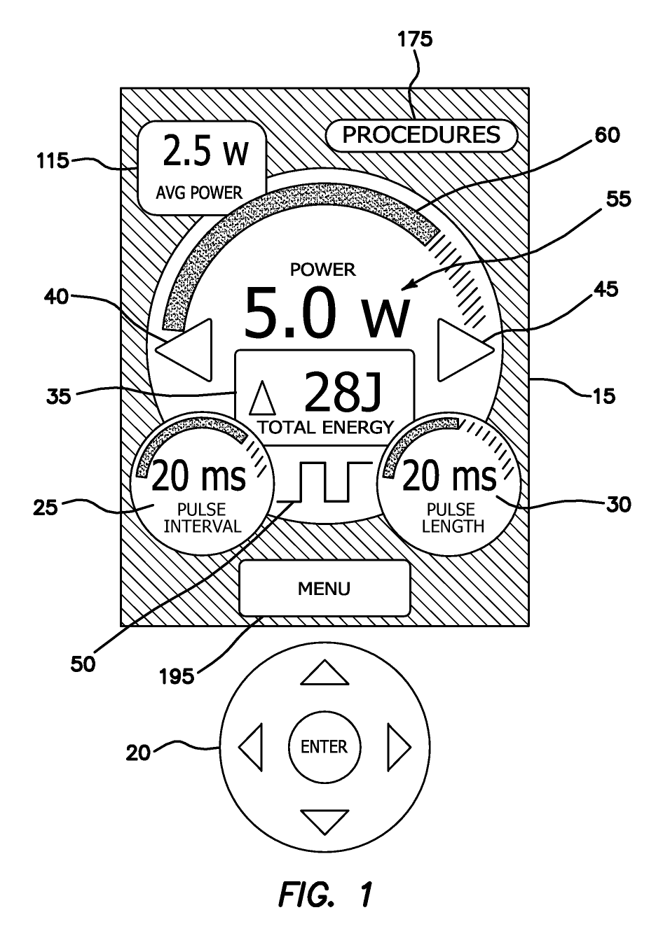

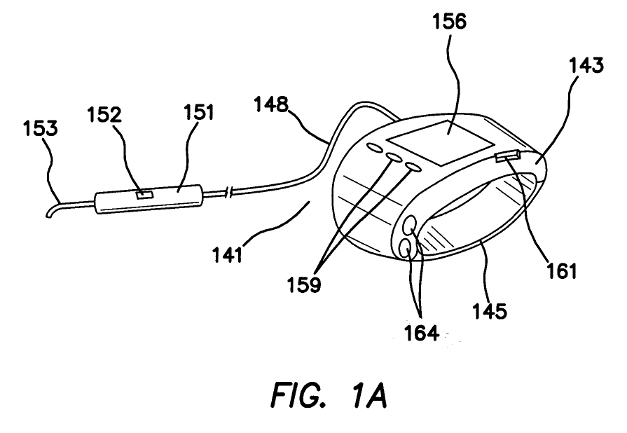

With reference to FIG. 1A, a wrist-mount lasing device is exemplified in the form of a body-mount implementation. The body-attachment (e.g., wrist mount) implementation of the wrist-mount lasing device 141 can comprise a housing 143 with a body attachment (e.g., a wrist band) 145, a fiber optic 148, and an output configuration. The housing can comprise, for example, a display, such as a touchscreen 156, inputs or controls 159, an electromagnetic energy source such as a laser 161, and batteries 164 which may comprise two sets of batteries.

According to one feature of the present invention, the display is oriented to face the user. Thus, the display can be oriented to have a top-to-bottom axis (on the display) that is perpendicular to a length of the user's arm (e.g., wrist portion of the arm) around which the device is designed to be affixed. In this way, a user wearing the device on, for example, her left wrist can face the device toward her, as she would a wrist watch, and have the display and controls oriented for optimal use thereof (e.g., “right side up”). According to one aspect of the invention, the user is able to accurately and conveniently view or adjust procedural parameters of the wrist-mounted laser, without having to direct her attention away from the surgical site, by positioning her wrist, with the wrist-mounted display and controls attached thereto, between her person and the surgical site. Thus, monitoring or adjustments can be made with absolutely minimal to nil distraction or delay. Furthermore, another feature of the invention comprises the user viewing or adjusting procedural parameters of the wrist-mounted laser by positioning her wrist, with the wrist-mounted display and controls attached thereto, in a line-of-sight between her eyes and the surgical site. In either implementation, or in any other implementation described or referenced herein, the laser output can be integrally formed with the wrist-mounted laser or can extend therefrom (e.g., in the form of a handpiece or finger piece, as referenced herein) to be attached to or held in the same or the other hand, finger or fingers of the user. Moreover, in any of these implementations the laser output can be ergonomically sized and shaped to facilitate the user's manipulation of or inputting of information into the wrist-mounted laser without having to set aside, put down, or let go of the laser output, whereby monitoring or adjustments can be made with minimal to nil distraction or delay.

The output configuration is embodied in this example as a handpiece 151 with an actuator control 152 for controlling, for example, an on/off state of an electromagnetic energy source (e.g., laser) and with a fiber optic tip 153. In the current or other embodiments described or referenced herein (e.g., an embodiment wherein the output configuration takes the form of only a fiber optic tip or of only a distal end of the fiber optic, either embodiment being formed alone or in conjunction with a fluid output), the actuator control may be omitted in lieu of a foot pedal and/or other controls. Moreover, the actuator may take the form of a greater number of input acceptors (e.g., buttons), rather than just the single button depicted in FIG. 27.

The above-referenced U.S. application Ser. Nos. 11/800,434 and 11/800,435 (the '43x applications) disclose electromagnetic energy output devices (e.g., a lasers) for implementing surgical, (e.g., dental) procedures on hard or soft tissue. The electromagnetic energy output devices disclosed therein can be configured, for example, to be particularly suited for soft tissue cutting or for ablating procedures. Other applications of the electromagnetic energy output devices can include decontamination, cleaning periodontal pockets, pain reduction, and biostimulation procedures.

Configuring one of the electromagnetic energy output devices for the above-listed and other applications can require that methods and apparatus be provided to control properties of the electromagnetic energy generated by the device. The devices disclosed in the '43x applications can employ, according to an aspect of the invention, graphical user interfaces implemented on a portable assembly capable of being held in a human hand. One possible implementation of such a device is illustrated in a perspective view of FIG. 26A of the '43x applications showing a possible implementation of a graphical user interface in the form of a touchscreen 156. The illustrated assembly may be operatively configured with an electromagnetic energy source as described in the '43x applications. The embodiment illustrated in FIG. 26A of the '43x applications further includes user-interface inputs comprising an ENTER input and four arrow inputs at the bottom of the device. The depicted assembly can be mounted, for example, to a wrist or wall (e.g., with a battery, with fewer hard or physical buttons and more of a display/software driven user interface, and shorter cables/fibers) as exemplified in FIGS. 15 and 18, respectively, of the '43x applications and as elucidated in the discussions pertaining to those figures.

A two-dimensional representation of a portion of an embodiment of a graphical user interface of a type illustrated in FIG. 26A of the '43x applications is illustrated in FIG. 1. The illustrated embodiment includes a touchscreen 15 as well as a control wheel 20 (described infra) having an ENTER input with four arrow inputs. The illustrated interface displays values for and may enable control of several parameters of an electromagnetic energy source adapted to perform, for example, surgical procedures as described in the '43x application. The illustrated interface includes a plurality of electromagnetic energy control icons 25, 30, 35, 40, 45, and 50, for example, which are explained individually in the sequel which follows.

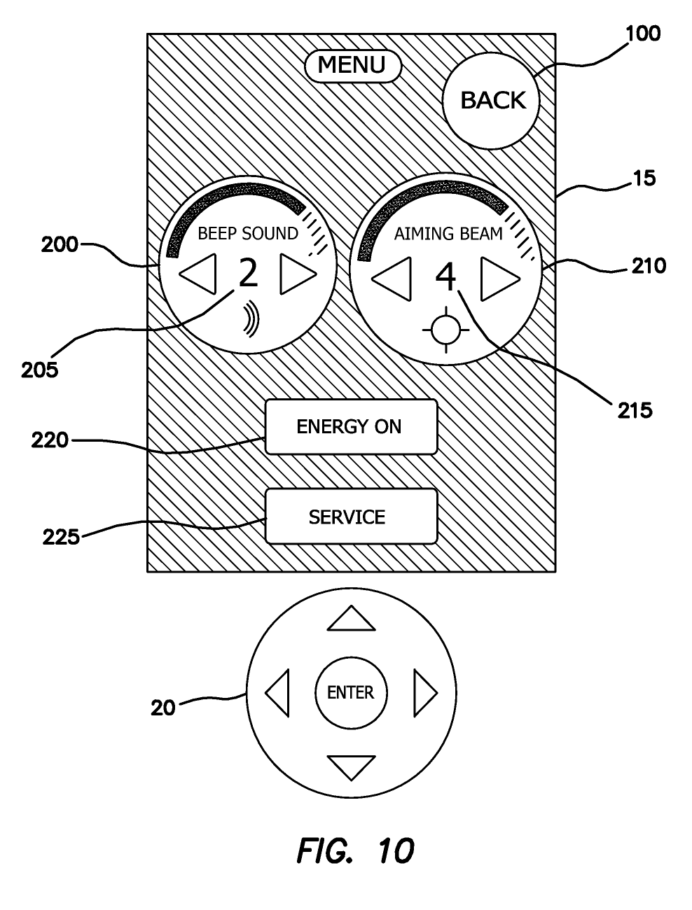

The graphical user interface of FIG. 1 further includes a power level indicator 55 adapted to display a level of power generated by the electromagnetic energy source. The level of power may be controlled by pressing (e.g., touching) a power decrease icon 40 in order to decrease the level of power generated by the electromagnetic energy source (and consequently, decrease the value of the power level displayed by the power level indicator 55). Similarly, the level of power may be increased by touching a power increase icon 45. The illustrated embodiment further includes a simulated analog representation 60 (as, for example, with a thermometer, speedometer and the like) of the power level relative to a maximum possible power level setting. Similar simulated analog representations appear, for example, in a pulse interval icon 25 and a pulse length icon 30, which icons are described infra. Icons 200 and 210 described infra relative to FIG. 10 include similar simulated analog representations.

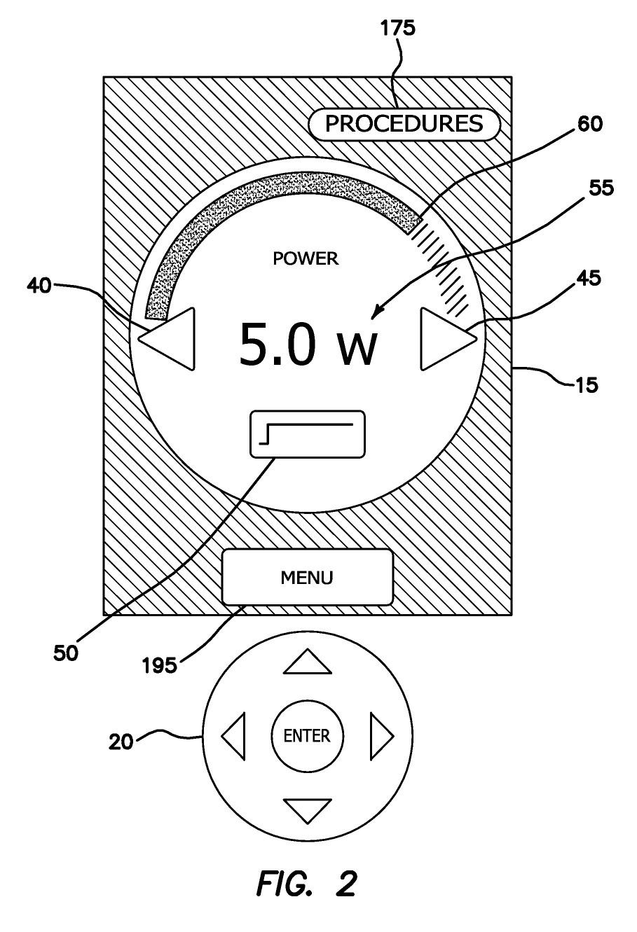

The illustrated graphical user interface further includes an energy mode icon 50, which both indicates and controls a mode of electromagnetic energy generation of the electromagnetic energy source. The energy mode icon 50 can be activated or “pressed” by (1) “selecting” it using the control wheel so that the icon is highlighted, e.g., by enhancing its border, and then “entering” that selection by pressing the ENTER button of the control wheel, or by (2) touching or clicking on the energy mode icon 50 using a finger or stylus. Upon activation, the energy mode may change from a pulsed energy mode corresponding to the graphical display shown in FIG. 1 to a continuous wave mode corresponding to a graphical display as shown in FIG. 2 wherein a form of the energy mode icon 50 changes to a continuous wave graphic, e.g., a blank or darkened area with a single square wave ramp-up followed by a steady-state value.

Pressing the energy mode icon 50 of FIG. 2 switches (e.g., toggles) back to the pulsed energy mode, and the graphical display again appears as shown in FIG. 1. As can be inferred from the terminology, the electromagnetic energy source may generate electromagnetic energy continuously when in the continuous wave mode and may generate energy in a form of pulses when in the pulsed energy mode.

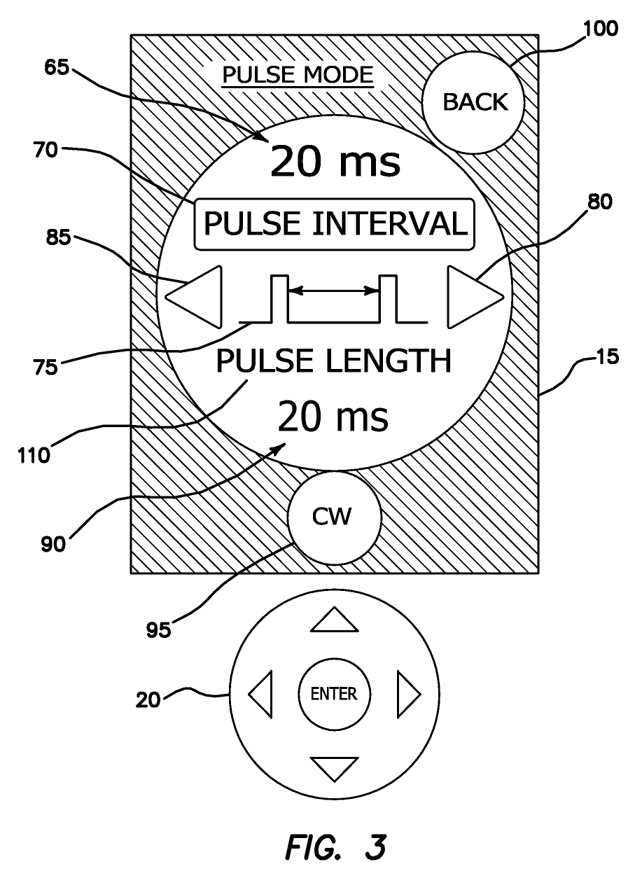

One implementation of the graphical user interface of FIG. 1, which may be used to control, for example, a laser handpiece, includes a pulse interval icon 25 and a pulse length icon 30. Selecting the pulse interval icon 25, according to the illustrated implementation, may highlight the pulse interval icon 25 (e.g., by enhancing its border). Subsequently, pressing ENTER with the highlighted pulse interval icon 25 selected may change the appearance of the graphical display to a screen as illustrated in FIG. 3, which includes an emphasized (e.g., bold, different color, or the like) value (e.g., 20 ms) for a pulse interval, the words “PULSE INTERVAL” 70 highlighted (e.g., outlined, different color, etc.) and a pulse interval graphic 75. A pulse interval increase icon 80 and a pulse interval decrease icon 85 are further included, which, when pressed, may, respectively, lengthen or shorten a time duration between pulses (i.e., an “OFF” time) of electromagnetic energy generated by the electromagnetic energy source. To store a value for pulse interval, the pulse interval increase/decrease icons 80/85 may be used and then the PULSE INTERVAL icon 70 may be pressed, which brings up the display of FIG. 1 with the pulse interval icon 25 displaying a (possibly) modified value.

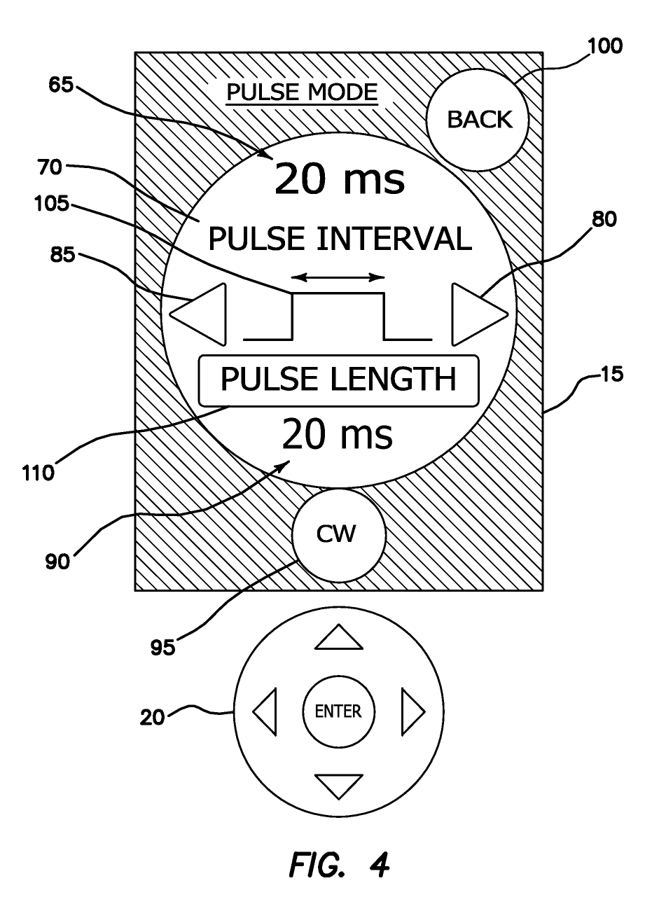

The illustrated screen of FIG. 3 further includes an indication of a pulse length 90, 110 (described more fully infra with reference to FIG. 4) and a “CW” icon 95, which when pressed may switch the electromagnetic energy source into a continuous wave mode and may change the display to the one shown in FIG. 2, thereby providing an alternative method of reaching the screen of FIG. 2. The implementation of FIG. 3 further includes a BACK icon 100, which, when pressed, may return the display to that shown in FIG. 1 without registering any changes made while in the screen of FIG. 3. In a modified embodiment, pressing the BACK icon 100 may register any changes made while in the screen of FIG. 3 and return the display to that shown in FIG. 1.

Returning to FIG. 1, selecting the pulse length icon 30 may highlight the pulse length icon 30 (e.g., by enhancing its border). Pressing ENTER with the highlighted pulse length icon selected may then change the graphical display to that illustrated in FIG. 4. Regarding the FIG. 4 display, it includes, in a manner analogous to the description of FIG. 3, a pulse length graphic 105, the words “PULSE LENGTH” 110 highlighted, and a value for pulse length 90 emphasized. Icons 85 and 80 change function in FIG. 4 from their roles in FIG. 3 and now may be used to adjust the length of pulses of electromagnetic energy generated by the electromagnetic energy source. Icons 85 and 80, therefore, function, respectively, as pulse length increase and pulse length decrease icons on the screen of FIG. 4. Adjusting the pulse length using icons 85/80 and then pressing the PULSE LENGTH icon 110 stores a new value for pulse length and returns the display to that of FIG. 1. As was the case for FIG. 3, pressing CW 95 in FIG. 4 may switch the electromagnetic energy source to the continuous wave mode and may cause the screen shown in FIG. 2 to be displayed. Pressing BACK 100 in FIG. 4 can return the display to that shown in FIG. 1 without registering any changes made while in the screen of FIG. 4.

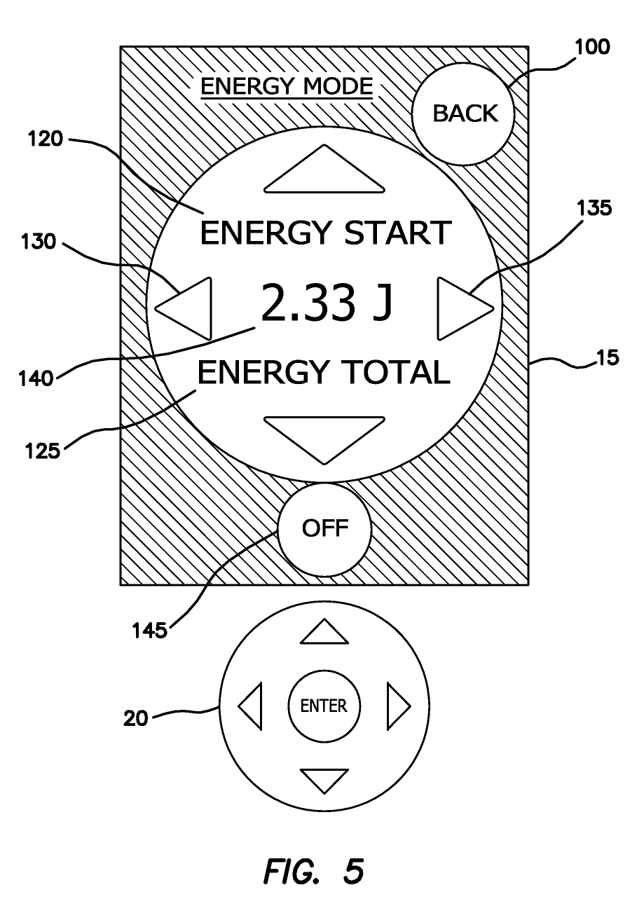

Returning again to FIG. 1, the illustrated embodiment further includes an average power indicator 115 that may display an average power level according to the power level of the electromagnetic energy source (shown by the power level indicator 55), the pulse interval (shown in the pulse interval icon 25) and the pulse length (shown in the pulse length icon 30). The implementation shown in FIG. 1 further includes a total energy level icon 35, which, in the indicated implementation, may function as both a total energy level indicator and as an electromagnetic energy control icon. As a total energy level indicator, the total energy level icon 35 may display (depending upon context as described infra with reference to FIG. 5) an amount of electromagnetic energy already generated or an amount of electromagnetic energy to be delivered by the electromagnetic energy source. As an electromagnetic energy control icon, the total energy level icon 35, when selected, may be highlighted; where after pressing ENTER with the highlighted energy level icon 35 selected may switch the graphical user interface to a screen as shown in FIG. 5.

The screen of FIG. 5 facilitates controlling energy delivered or to be delivered by the electromagnetic energy source. The screen comprises an ENERGY START icon 120, which, when pressed, enables calculation of electromagnetic energy delivered (e.g., to tissue). The screen of FIG. 5 further comprises an ENERGY TOTAL icon 125, an energy decrease icon 130, and an energy increase icon 135. The total energy delivered or to be delivered may be displayed, according to the illustrated embodiment, with an energy indicator 140; an initial value of energy displayed by the energy indicator 140 can be adjusted downward by pressing the energy decrease icon 130 or adjusted upward by pressing the energy increase icon 135. (In an exemplary mode of operation, the value displayed in the energy indicator 140 is adjusted to zero when the ENERGY START icon 120 is pressed.) Pressing the ENERGY TOTAL icon 125 may set a total amount of energy to be delivered by the electromagnetic energy source. For example, to deliver a total of 5 joules (watt-seconds) of energy, the value displayed by the energy indicator 140 may be adjusted to 5.00 using the energy decrease 130 and energy increase 135 icons and then pressing the ENERGY TOTAL 125, or visa versa.

According to one operating mode, inputs presented to the touchscreen are accepted as parameter values for the electromagnetic energy source. The electromagnetic energy source may be turned on/off using a foot pedal or switch (not shown). When turned on by the foot switch, the electromagnetic energy source may generate energy according to the parameter values. For example, the electromagnetic energy source may deliver the set amount of energy represented by the ENERGY TOTAL icon 125 (either continuously with the foot switch turned on continuously or cumulatively in bursts if the foot switch is turned on and off) and then cease to deliver energy. For example, at a power level of 0.5 watts, the electromagnetic energy source would operate for a total of 10 seconds to deliver 5 joules of energy while the foot switch is on. It should be understood that the foot switch may be turned on for, as an example, five separated two-second periods for the total electromagnetic energy delivered to reach 5 joules. Pressing either ENERGY START 120 or ENERGY TOTAL 125 may cause a return to the screen of FIG. 1 with a (possibly) new value for total energy shown by the total energy indicator 35.

The illustrated screen of FIG. 5 further comprises an OFF icon 145, which, when pressed, may turn off the electromagnetic energy source.

A non-touchscreen operating mode for the screens described above relative to FIGS. 1-5 comprises using the control wheel 20 illustrated, for example, in FIG. 1. According to this operating mode, one of the plurality of electromagnetic energy control icons in, for example, FIG. 1 may be highlighted. Pressing an up or down arrow of the control wheel 20 may control which icon is highlighted. When an icon is highlighted, pressing ENTER on the control wheel 20 is equivalent to pressing the icon (highlighted or not) on the touchscreen. In FIGS. 3 and 4, pressing the up/down arrows on the control wheel 20 may cause, successively, the PULSE INTERVAL 70, PULSE LENGTH 110, and CW 95 icons to be highlighted (e.g., shown with a yellow background). Pressing the left/right arrows on the control wheel may adjust highlighted numerical values on the touchscreen, and pressing ENTER may store the new values and return to the screen of FIG. 1. Similarly, in FIG. 5, pressing the up/down arrows on the control wheel 20 may cause the ENERGY START 120, ENERGY TOTAL 125, and OFF 145 icons to be successively highlighted. Pressing the left/right icons on the control wheel 20 may decrease/increase a numerical value associated with a highlighted icon, and pressing ENTER may store the numerical value and return the display to that of FIG. 1.

The preceding description describes a portion of possible transitions among screens of the forms shown in FIGS. 1-5. Other configurations and/or sequences are possible as will readily occur to one skilled in the art. These other configurations and/or sequences are contemplated by the present disclosure.

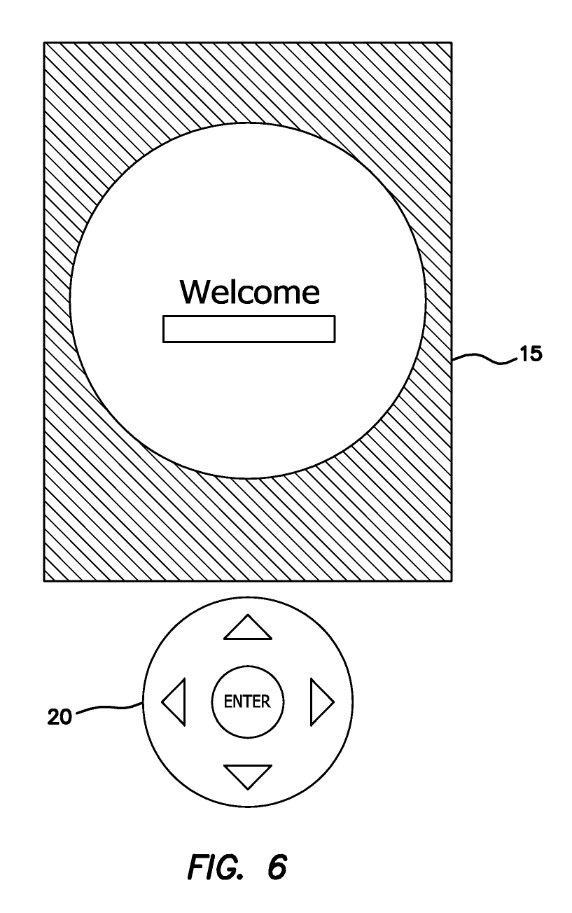

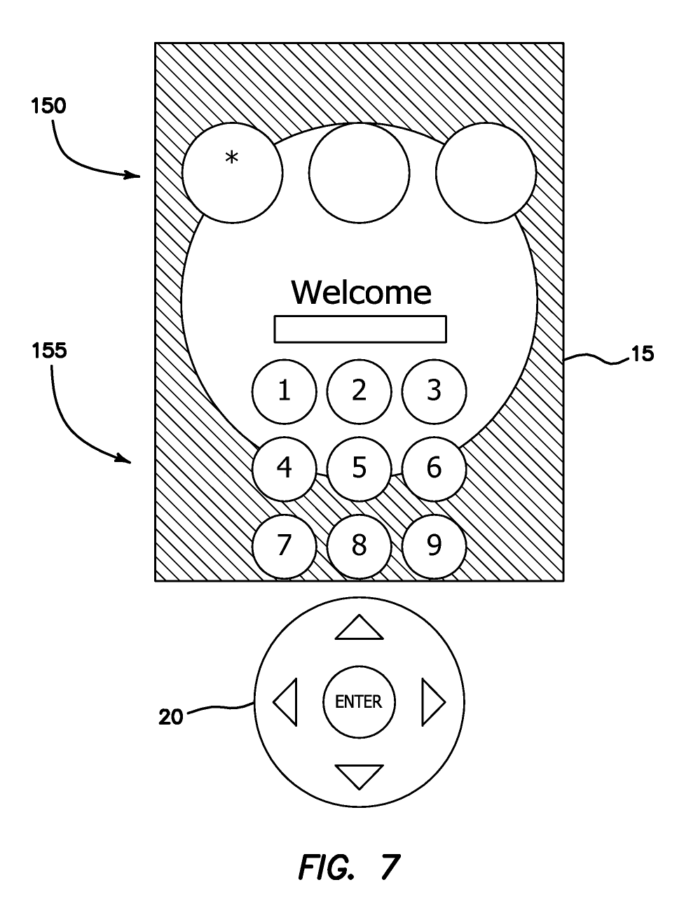

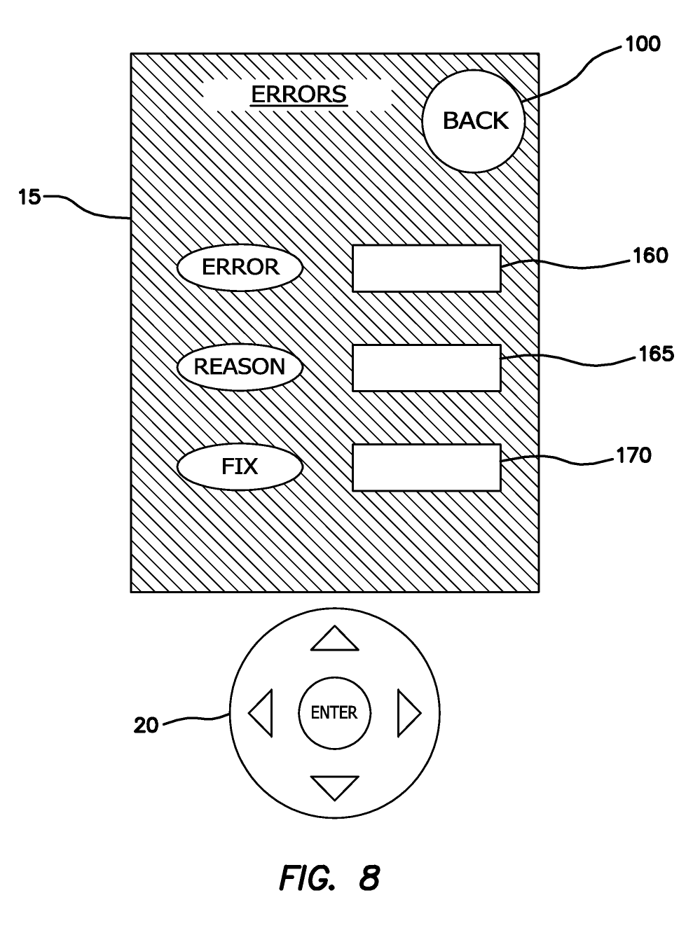

Additional screens in the graphical user interface may provide additional support functions that may be helpful to a user. For example, on power-up, a first welcome screen may be displayed as shown in FIG. 6. In accordance with a representative embodiment, the first welcome screen of FIG. 6 automatically transitions after a few seconds to a second welcome screen as illustrated in FIG. 7. The second welcome screen may comprise a plurality of fields 150 (three are shown in FIG. 7) wherein a user may be invited to enter an access code using, for example, a keypad 155 either in a touchscreen mode or by using the control wheel 20 to select each digit from the keypad and then pressing ENTER to place that digit in one of the fields 150. When a valid access code is entered, the screen may transition to that shown in FIG. 1, and a user may commence normal operation. If an invalid access code is entered, then an error screen, an example of which is illustrated in FIG. 8, may be displayed. According to the illustrated embodiment, a field 160 on the error screen may identify an error, and a field 165 may provide a brief explanation of the error, with another field 170 explaining how the error may be fixed. The BACK icon 100 may enable a user to restart from the second welcome screen (FIG. 7).

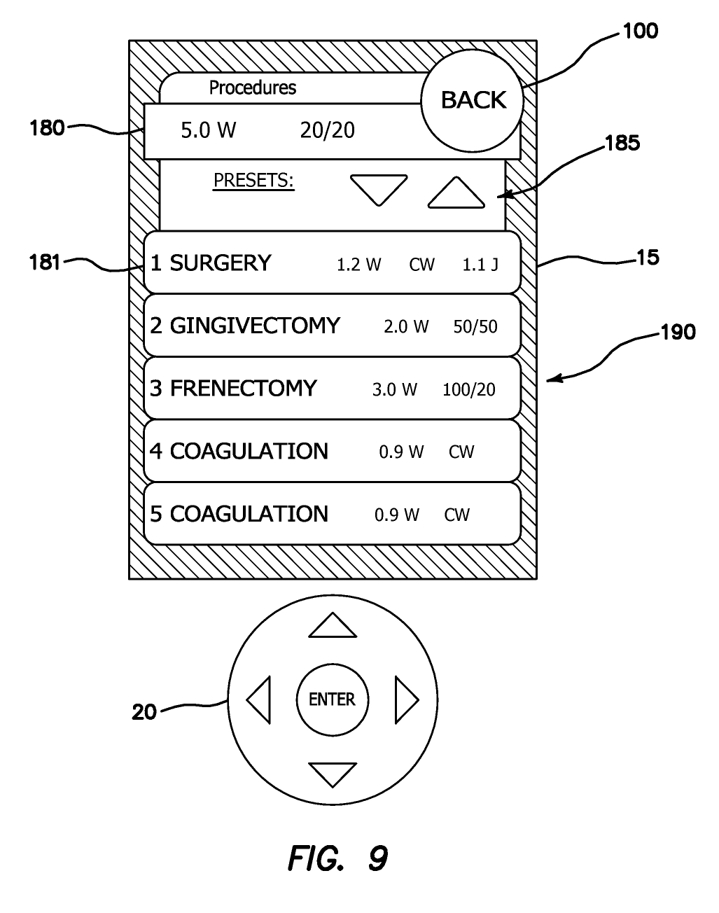

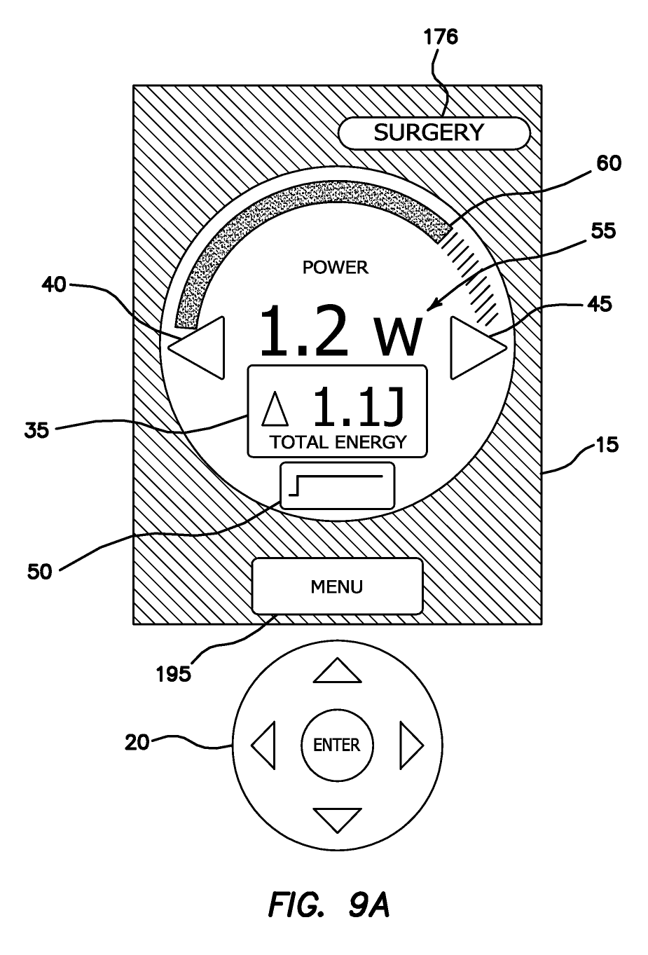

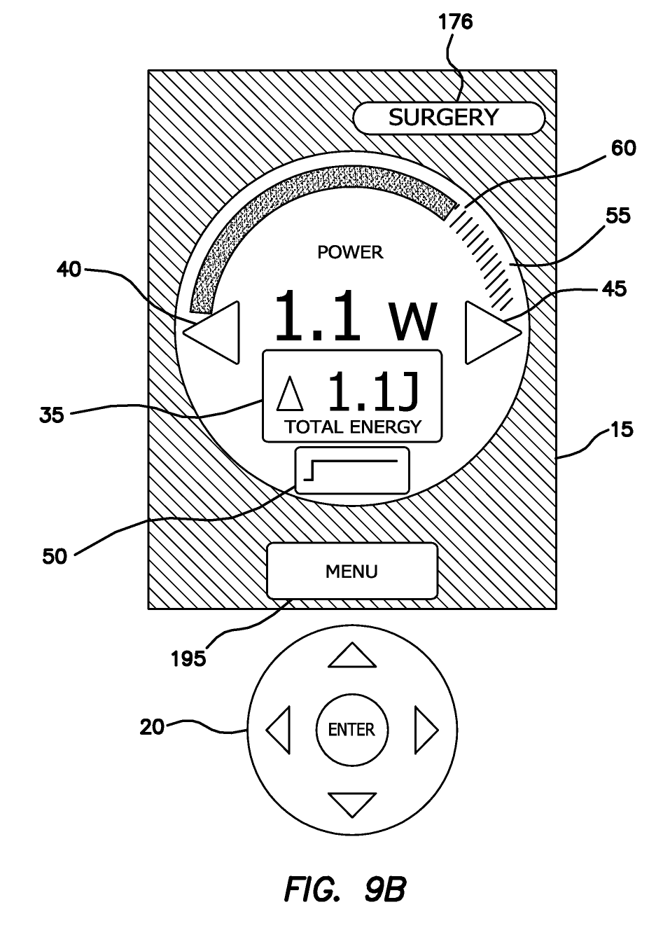

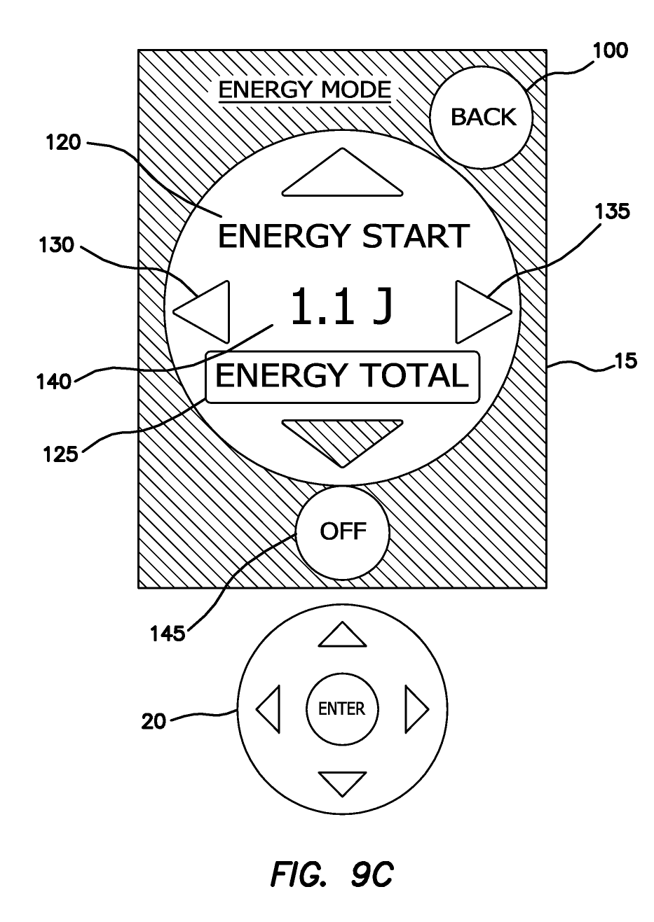

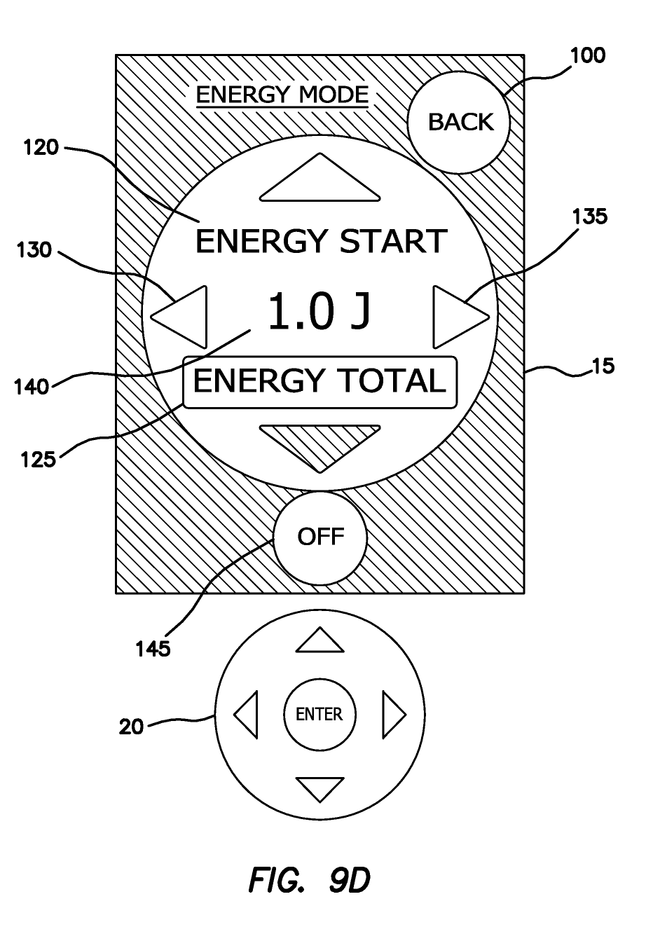

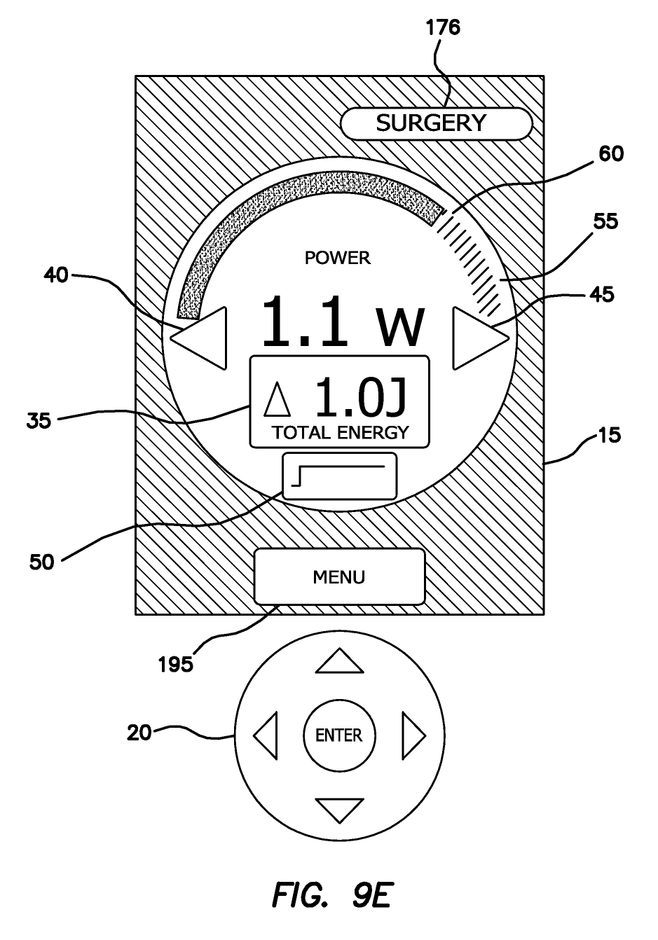

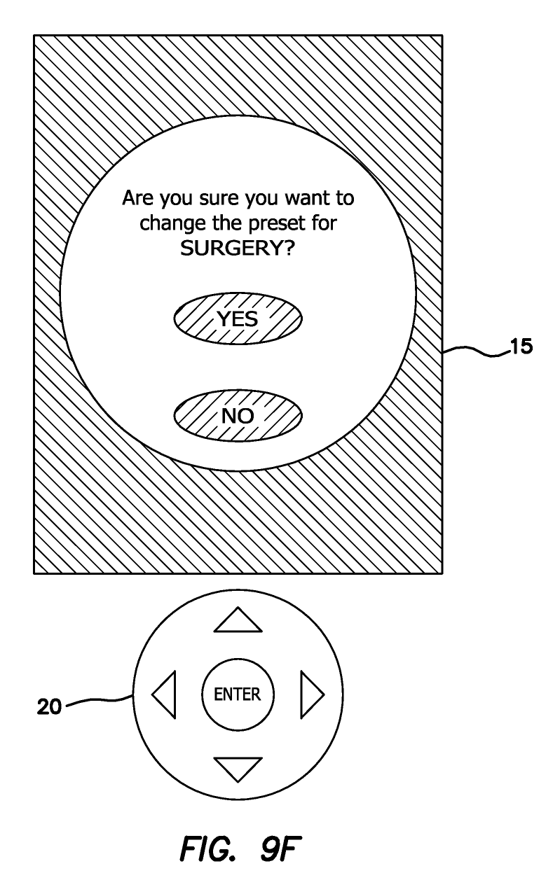

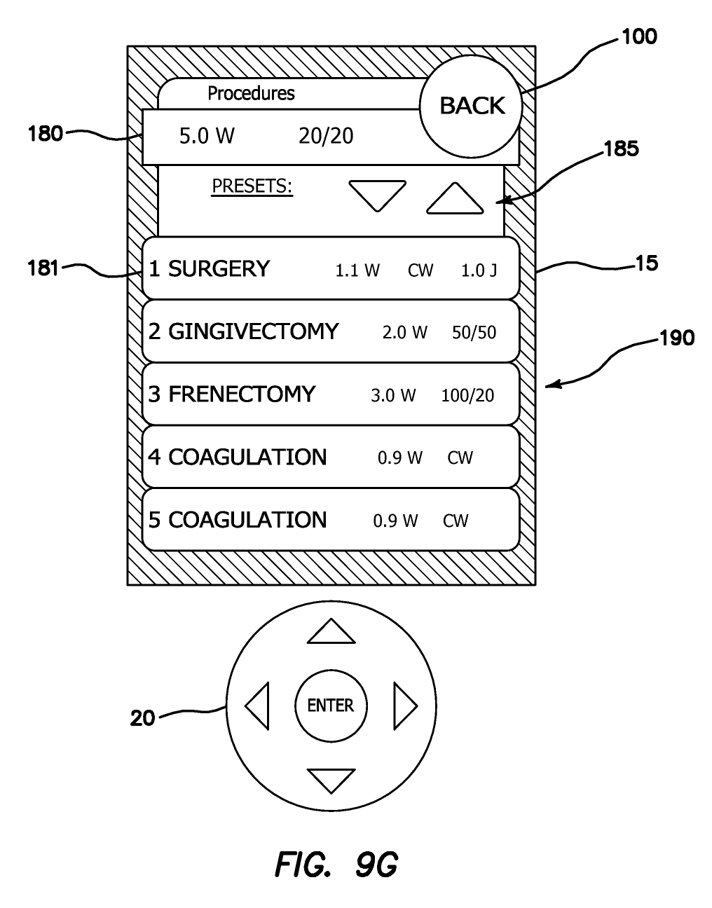

The screen of FIG. 1 (and, as another example, FIG. 2) comprises a PROCEDURES icon 175, which when pressed, may bring up a procedures screen, an example of which is shown in FIG. 9. The procedures screen of FIG. 9 contains a field 180 displaying current settings of the electromagnetic energy output device. In the illustrated example, the device is set at a power level of 5.0 W in a pulse mode with 20 ms pulse length and a 20 ms pulse interval.

An embodiment of the procedures screen further comprises a PRESETS field having up/down arrows 185 that may cause a scrollable list of procedure icons 190 to be scrolled, up or down. Each of several presets may comprise a particular combination of values for each of several parameters for controlling the electromagnetic energy output system according to a particular procedure. Parameters may include power level, total energy level, energy mode, pulse length, and pulse interval, among others. Pressing one of the procedure icons may adjust or “preset” the electromagnetic energy output device according to settings listed on that procedure icon. For example, pressing (i.e., touching) a SURGERY icon 181 in FIG. 9 may set the electromagnetic energy output device to a power level of 1.2 watts in a continuous wave mode with a total energy to be delivered of 1.1 joules.

According to another embodiment, pressing (i.e., selecting) a procedure icon on the procedures screen twice in rapid succession [or prefacing a single pressing with a pressing of, for example, a MODIFY icon (not shown)] may return the user to a screen having a modified form of FIG. 1 (if the selected procedure employs the pulse mode) or FIG. 3 (if the selected procedure employs the continuous wave mode) wherein a user may adjust values of preset parameters. For example, pressing the SURGERY icon 181 may display the screen shown in FIG. 9A, the form of which can be likened to that of FIG. 3, wherein the BACK icon 100 of FIG. 3 is replaced by a procedure identifier 176 (i.e., SURGERY in the present example). In accordance with the parameter values displayed in the SURGERY icon 181 of FIG. 9, the power level indicator 55 in FIG. 9A displays a power level of 1.2 W, the energy mode icon 50 indicates a continuous wave mode of electromagnetic energy generation, and the total energy to be delivered, as indicated by the total energy level icon 35, is 1.1 joules. If a user, on a basis for example of personal preference or experience, wishes to change parameter values for one or more of the presets given in FIG. 9, a natural and convenient capability for such a change may be provided on the screen of FIG. 9A. A user may, for example, use the power increase/decrease 45/40 icons to adjust the power level. As shown in FIG. 9B, the user may adjust the power level to 1.1 W as indicated by the power level indicator 55.

As a further example, the user may wish to reduce the total energy delivered from 1.1 joules to, say, 1.0 joule. As will be readily appreciated by the user, according to an aspect of the invention, an intuitive and natural way of making such a change comprises pressing the total energy level icon 35 when, for example, the screen of FIG. 9B is displayed. Pressing the total energy level icon 35 may bring up a screen similar to that of FIG. 5, but with the ENERGY TOTAL icon 125 highlighted as shown in FIG. 9C. Using the energy increase/decrease icons 135/130, the user may adjust the total energy, for example, to 1.0 joules as shown in FIG. 9D. Pressing the ENERGY TOTAL icon 125 then may return the user to the display of FIG. 9B, but with the value of total energy now modified to 1.0 joules as shown in FIG. 9E. Pressing the procedure identifier 176 (displaying, for example, SURGERY in FIGS. 9A, 9B, and 9E), may return the user to a display of the procedures menu of FIG. 9, but with modified values according to changes made as just described. As a safety measure, an intermediate “Are you sure . . . ?” screen similar to that shown in FIG. 9F may be displayed. If a user selects YES on the screen, then the modified procedures screen may be displayed as shown in FIG. 9G. If the user selects NO, then any modifications may be lost, and the user returned to the procedures screen (FIG. 9) without any changes.

A plurality (which may total, e.g., 15) of presets may be included, the presets relating to, in addition to surgery, coagulation and, in other examples, dental procedures for gingivectomy, troughing, curettage, excision, frenectomy, and the like. Custom presets may also be provided that may be conveniently and intuitively configured by a user in a manner similar to the modification of the SURGERY presets as described supra. According to yet another operating mode, a user may adjust values of parameters for a procedure on a main menu (on, for example, a screen similar to that shown in FIG. 1), by selecting the PROCEDURES mode (by, for example, pressing the PROCEDURES icon in FIG. 1) and then pressing and holding an icon corresponding to a name of the procedure for 2 seconds to change and store new parameters for the procedure.

Some screens of the graphical user interface (e.g., FIGS. 1 and 2) are constructed to include a MENU icon 195. Pressing the MENU icon 195 may bring up a screen as shown in FIG. 10 that includes icons for enabling control of other aspects of an electromagnetic energy output system. For example, the screen may include, as shown, a BEEP SOUND icon 200 including a beep sound indicator 205 that displays a beep sound level, which level may be increased or decreased by operation of increase/decrease icons displayed as part of the icon. The beep sound may be heard when, for example, a user presses an icon on the graphical user interface described herein with reference to FIGS. 1-12. Similarly, an AIMING BEAM icon 210 may be included, the AIMING BEAM icon 210 including an aiming beam indicator 215 indicative of an intensity or brightness level of an aiming beam, which may be used in some applications to illuminate an area of, for example, tissue to be treated by a laser beam produced by the electromagnetic energy output system. The brightness level may be adjusted up or down by way of increase/decrease icons included as part of the AIMING BEAM icon 210.

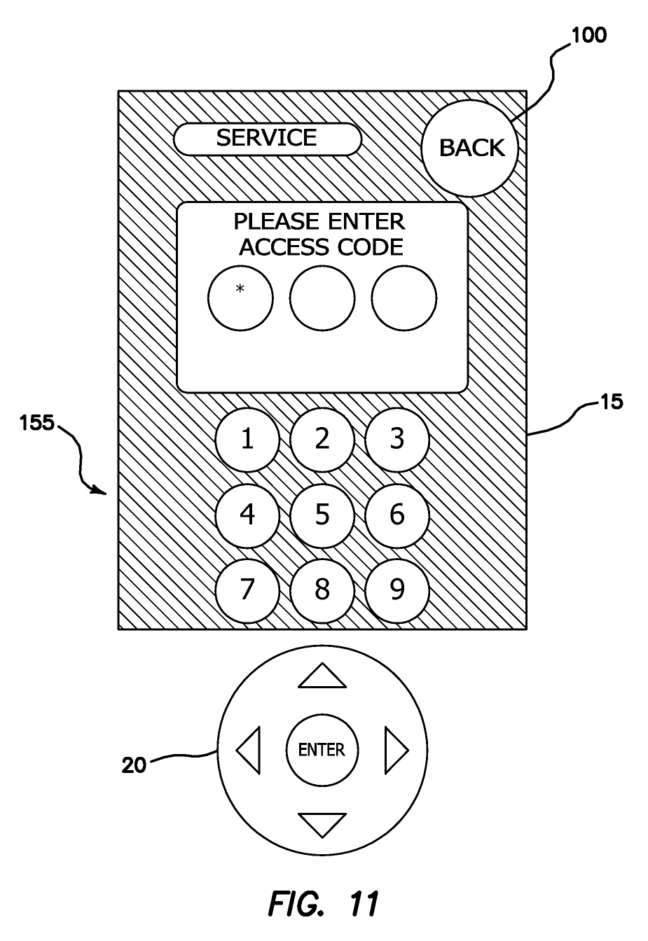

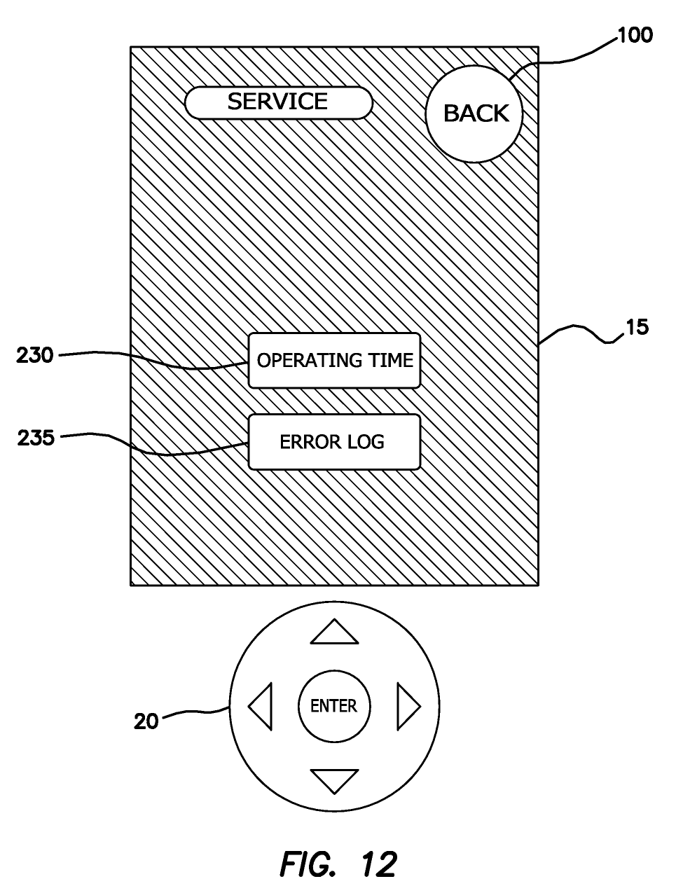

The screen of FIG. 10 may further comprise an ENERGY ON icon 220, which, when pressed, may turn on the electromagnetic energy source after storing and activating any changes made in, for example, beep sound or aiming beam brightness and which, in accord with one embodiment, may bring up the screen of FIG. 1. The screen of FIG. 10 still further may comprise a SERVICE icon 225, which, when pressed, may bring up a service screen, an example of which is illustrated in FIG. 11. The service screen of FIG. 11 may include a facility for entering an access code (cf. FIG. 7). If a valid access code is entered, then a user may be presented with a screen similar to that shown in FIG. 12, which may permit the user to select, for example, a display of operating time or an error log, reachable by pressing, for example, an OPERATING TIME icon 230 or an ERROR LOG icon 235.

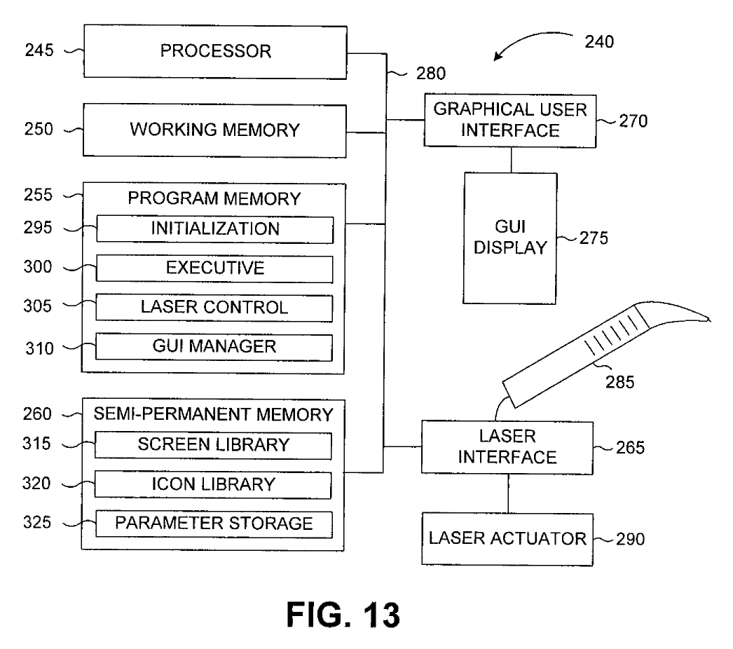

An embodiment of a computer system 240 that may be adapted to independently adjust pulse length and pulse interval of electromagnetic energy generated in a pulse mode by a laser handpiece is illustrated in FIG. 13. The embodiment depicted in FIG. 13 may include the graphical user interface (GUI) 270 described supra with reference to FIGS. 1-12. The illustrated embodiment, which may be disposed in a portable assembly easily held in a hand as illustrated, for example, in FIG. 20B of the '43x applications, comprises a processor 245, working memory 250, which may be random-access memory, program memory 255, semi-permanent memory 260, which may be flash memory in some embodiments, a laser interface 265, and a graphical user interface 270. A system bus 280 may communicatively interconnect the aforementioned elements. The illustrated embodiment further includes a GUI display 275 responsive to signals received from the graphical user interface 270. The GUI display 275 may be of a touchscreen type in some embodiments adapted to receive user input in a form of touches to icons on the GUI display 275. Typical embodiments include an electromagnetic energy output device such as a laser handpiece 285 and further include, for example, a laser actuator 290. The laser actuator 290 may take a form of, according to one embodiment, a foot-operated switch that interacts with the laser interface 265 in accordance with signals received from the processor 245 in order to control the electromagnetic energy output device.

The program memory 255 of the illustrated computer system 240 may have stored therein software modules that, when executed, may cause the processor 245 to perform certain functions according to the software modules. For example, software modules comprising an initialization module 295, an executive module 300, a laser control module 305, and a graphical user interface manager 310 may be included. Additionally, the semi-permanent memory may store such items as a screen library 315 and an icon library 320 and, further, may include locations identified in FIG. 13 as parameter storage 325 for storing system parameters.

According to one exemplary mode of operation, the processor 245 in the computer system 240 may, upon power-up, execute the initialization module 295, which may cause the processor 245 to perform certain initialization tasks such as recalling parameter values from parameter storage 325, which parameters may determine settings for an electromagnetic energy source such as the laser handpiece 285 (e.g., power level, pulse length, etc.). The processor 245, further, may communicate with the GUI manager 310, which may cause the processor 245 to retrieve a welcome screen from the screen library 315 and to present the welcome screen on the GUI display 275 (cf. FIG. 6). The processor 245 may then execute the executive software module 300, which may cause the processor 245 to execute the GUI manager module 310. The GUI manager 310 may cause the processor 245 to retrieve from the screen library 315 and to display a modified welcome screen such as that shown, for example, in FIG. 7, which may invite a user to enter an access code into the GUI display 275. If an invalid access code is received by the processor 245, then the GUI manager 310 may cause the processor 245 to display on the GUI display 275 an error screen, an example of which is illustrated in FIG. 8. Upon receiving a valid access code, the GUI manager 310 may cause the processor 245 to retrieve from the screen library 315 and to display on the GUI display a main screen of a form illustrated, for example, in FIG. 1. Details of the display may be influenced by values of parameters found in parameter storage 325, which values may be used by the processor 245 to modify icons retrieved from the icon library 320 and used to populate the main screen.

Thereafter, the computer system 240 of FIG. 13 may perform functions relative to the GUI display 275 as described supra with reference to FIGS. 1-12 in a manner that will be apparent to one skilled in the art.

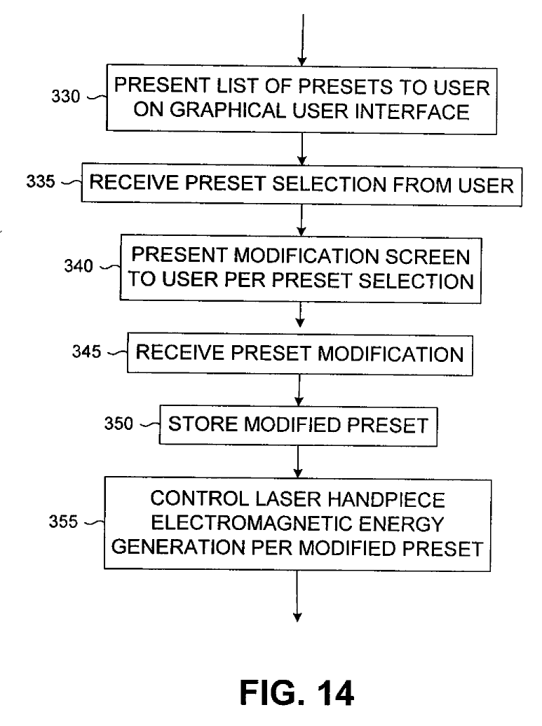

FIG. 14 is a flow diagram illustrating one implementation of a method of controlling an electromagnetic energy output system according to an implementation of the present invention. The illustrated example comprises presenting presets to a user on a graphical interface at step 330. The graphical interface may present, at step 330, a screen comprising a scrollable list of procedure icons 190 similar to, for example, the screen illustrated in FIG. 9, wherein procedure icons 190 are identified by a name for each procedure and which screen, further, may display a summary of parameter values associated with the procedure. According to one exemplary embodiment, a user may adapt one or more operational settings of the electromagnetic energy output system according to unique criteria such as personal preference or experience, in a convenient and intuitive manner, thereby enhancing versatility of the electromagnetic energy output system. As such, the graphical user interface may provide for a quick, convenient, and easy means to modify operating modes of the electromagnetic energy output system.

User input may be received at step 335 in a form, according to a typical embodiment, of a touch to a screen of a graphical user interface, the screen presenting a display of a form of, for example, FIG. 9, by which touch the user selects a preset from the scrollable list of procedure icons 190. A modification screen may be presented at step 340 according to the selected preset. For example, a screen similar to that shown in FIG. 9A may be presented, wherein a user is able to adjust (i.e., modify) preset power and total energy settings in a manner described supra in connection with the discussion of FIGS. 9A-9G. Modifications to the preset values may be received at step 345 according to user inputs as likewise described supra in connection with the discussion of FIGS. 9A-9G, and the modified preset may be stored at step 350 as described above with regard to FIGS. 9E-9G. The electromagnetic energy source (e.g., a laser handpiece) thereafter may be controlled at step 355 according to the modified preset.

In view of the foregoing, it will be understood by those skilled in the art that the methods and apparatuses of the present invention can facilitate rapid, intuitive, accurate and efficient control of an electromagnetic energy output system. The above-described embodiments have been provided by way of example, and the present invention is not limited to these examples. Multiple variations and modification to the disclosed embodiments will occur, to the extent not mutually exclusive, to those skilled in the art upon consideration of the foregoing description. Additionally, other combinations, omissions, substitutions and modifications will be apparent to the skilled artisan in view of the disclosure herein. Accordingly, the present invention is not intended to be limited by the disclosed embodiments, but is to be defined by reference to the appended claims.

What is claimed is:

1. A laser device adapted to generate electromagnetic energy according to a plurality of display activated and controllable parameters, the device comprising:
an electromagnetic energy source;
a microprocessor;
a graphical user interface adapted to present the plurality of display activated and controllable parameters to a user, the graphical user interface further being adapted to receive adjustments to one or more of the plurality of the display activated and controllable parameters;
a touchscreen provided as a part of the graphical user interface;
a plurality of electromagnetic energy control icons displayed on the touchscreen; and
circuitry and software operationally coupling the graphical user interface and the microprocessor to the electromagnetic energy source, to facilitate communication among the graphical user interface, the microprocessor, and the electromagnetic energy device, whereby the microprocessor is enabled to control the electromagnetic energy source with commands according to user-inputted adjustments received from a user by way of the user's selection of one or more of the plurality of electromagnetic energy control icons of the touchscreen of the graphical user input device, wherein the electromagnetic energy source is responsive to the commands to vary a non-zero output of electromagnetic energy in response to one or more of the commands.

2. A laser device adapted to generate electromagnetic energy according to a plurality of display activated and controllable parameters, the device comprising:
a graphical user interface having a desktop viewable image that is scrollable using up and down arrows, the interface being adapted to present the plurality of parameters to a user, the graphical user interface being further adapted to receive adjustments to the plurality of preset parameter values, the graphical user interface comprising a touchscreen that is operably connected with an electromagnetic energy source; and
a plurality of electromagnetic energy control icons displayed on the touchscreen, wherein the electromagnetic energy source is responsive to inputs caused by touching at least one of the electromagnetic energy control icons.

3. A laser device adapted to generate electromagnetic energy according to a plurality of display activated and controllable parameters, the device comprising:
a graphical user interface having a desktop viewable image that is scrollable using a wheel, the interface being adapted to present the plurality of parameters to a user, the graphical user interface being further adapted to receive adjustments to the plurality of preset parameter values, the graphical user interface comprising a touchscreen that is operably connected with an electromagnetic energy source; and
a plurality of electromagnetic energy control icons displayed on the touchscreen, wherein the electromagnetic energy source is responsive to inputs caused by touching at least one of the electromagnetic energy control icons.

4. The laser device as set forth in any of claims 1, 2 or 3, wherein one or more of the plurality of electromagnetic energy control icons comprises an animated or virtual group of pages arranged as a stack or tablet of pages.

5. The laser device as set forth in claim 4, wherein the group comprises displayed elements of information elucidating one or more of settings, instructions, a user manual of the laser device, and databases of records, associations procedural steps.

6. The laser device as set forth in claim 4, wherein the group comprises displayed groups of information elucidating one or more of settings, instructions, a user manual of the laser device, and databases of records, associations procedural steps.

7. The laser device as set forth in claim 4, wherein the group comprises displayed elements and displayed further groups of information elucidating one or more of settings, instructions, a user manual of the laser device, and databases of records, associations procedural steps.

8. The laser device as set forth in claim 7, wherein combinations of elements are displayed on the touchscreen using one or more of stacked, partially overlapping, and fully overlapping images.

9. The laser device as set forth in claim 7, wherein combinations of groups are displayed on the touchscreen using one or more of stacked, partially overlapping, and fully overlapping images.

10. The laser device as set forth in claim 7, wherein combinations of elements and groups are displayed on the touchscreen using one or more of stacked, partially overlapping, and fully overlapping images.

11. The laser device as set forth in claim 5, wherein one or more of the elements and groups are factory installed.

12. The laser device as set forth in claim 5, wherein one or more of the elements and groups are created by a user.

13. The laser device as set forth in claim 5, wherein one or more of the elements and groups are created by a user from a factory-installed element or group.

14. The laser device as set forth in claim 5, wherein the elements and groups are factory installed and further are creatable and modifiable by a user.

15. The laser device as set forth in claim 5, wherein the elements, groups, and/or combinations of groups, are factory installed and/or creatable or modifiable by a user.

16. The laser device as set forth in any of claims 1, 2 or 3, wherein one or more of the groups comprises a top virtual page and additional virtual pages beneath it.

17. The laser device as set forth in any of claims 1, 2 or 3, whereby upon selection by a user of a top page of a group the group undergoes a motion animatedly resembling a turning of the top page to an underlying page.

18. The laser device as set forth in claim 17, the underlying page comprising one or more of further information and a further menu on or relating to the selected top page.

19. The laser device as set forth in claim 16, whereby one or more of the elements on a top page of a group is selectable by a user to open-up or move-to another page or element.

20. The laser device as set forth in claim 19, the other page or element, corresponding to a selected element on the top page, comprising one or more of further information and a further menu on or relating to the selected element on the top page.

21. The laser device as set forth in any of claims 1, 2 or 3, the top page comprising a listing, menu or outline of elements resembling a table of contents of a book.

22. The laser device as set forth in any of claims 1, 2 or 3, wherein selection of a given element on a page may comprise moving a displayed pointing device over the element or highlighting the element, and/or entering one or more confirmation inputs (e.g., one or more of a click of a pointing device, depression of a button or arrow on a housing of the user interface, a return or enter key, and a contacting of a user's finger or stylus on a part of a touchscreen).

23. The laser device as set forth in any of claims 1, 2 or 3, wherein turning of a page comprises a user selecting the page and sliding, moving or translating a pointer over a region of the selected page.

24. The laser device as set forth in any of claims 1, 2 or 3, wherein turning of a page comprises a user contacting the page and, while still contacting the page, moving or sliding a pointer over a region of the page.

25. The laser device as set forth in any of claims 1, 2 or 3, wherein turning of a page comprises a user touching an edge or corner of the page and, while still contacting the edge or corner, moving or sliding a pointer over a region of the page.

26. The laser device as set forth in any of claims 1, 2 or 3, wherein turning of a page comprises a user touching an edge or corner of the page with a finger or stylus and, while still contacting the edge or corner, moving or sliding the finger or stylus over a region of the page in a direction away from the edge or corner.

27. The laser device as set forth in any of claims 1, 2 or 3, wherein selection of a page comprises a user contacting a point on the page followed by sliding, moving or translating a pointer from the point over a region of the page.

28. The laser device as set forth in any of claims 1, 2 or 3, wherein selection of a page comprises a user contacting a region on the page followed by sliding, moving or translating a pointer from the region toward a more central region of the page.

29. The laser device as set forth in any of claims 1, 2 or 3, wherein selection of a page comprises a user touching an edge or corner of the page with a finger or stylus and, while still contacting the edge or corner, moving or sliding the finger or stylus over a part of the display.

30. The laser device as set forth in any of claims 1, 2 or 3, wherein selection of a page comprises a user moving or translating a pointer over a region of the page.

31. The laser device as set forth in any of claims 1, 2 or 3, wherein selection of a page comprises a user touching an edge or corner of the page with a finger or stylus and, while still contacting the edge or corner, moving or sliding the finger or stylus to a more central region of the page so as to “flip” or “turn” the page as would occur with a non-virtual page of a book.

32. The laser device as set forth in any of claims 1, 2 or 3, and further comprising a wrist band.

33. The laser device as set forth in any of claims 1, 2 or 3, wherein the touchpad is disposed over the display.

34. The laser device as set forth in any of claims 1, 2 or 3, and further comprising a scroll-wheel.
